(19) United States
(12) Patent Application Publication
(10) Pub. No.: US 2006/0121322 A1
(43) Pub. Date: Jun. 8, 2006

(54) Systems and methods for fuel cell shutdown

(76) Inventors: Herwig R. Haas, Vancouver (CA); Sybel M.C. Chor, Vancouver (CA); Liviu-Ion Cosacescu, Burnaby (CA); Reza Rahmani, Vancouver (CA); Christopher J. Richards, New Westminster (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/003,626

(22) Filed: Dec. 2, 2004

(51) Int. Cl. H01M 8/04

(52) U.S. Cl. 429/13; 429/26

(57) ABSTRACT

Methods and systems for improving the ability of a fuel cell stack to start following freezing conditions, including directing a drying stream through at least a portion of the fuel cell stack, directing a rehumidifying stream through at least a portion of the fuel cell stack prior to shutting down the power generating system.

### BACKGROUND OF THE INVENTION

1. Field of the Invention

The present systems and methods relate to improving water distribution within a fuel cell during shutdown, and particularly, to improve the ability of a fuel cell stack to start following exposure to freezing conditions.

2. Description of the Prior Art

Fuel cell systems are presently being developed for use as power supplies in a wide variety of applications, such as stationary power plants and portable power units. Such systems offer the promise of economically delivering power while providing environmental benefits.

Fuel cells convert fuel and oxidant reactants to generate electric power and reaction products. They generally employ an electrolyte disposed between cathode and anode electrodes. A catalyst typically induces the desired electrochemical reactions at the electrodes.

One type of fuel cell type suitable for portable and motive applications, is the solid polymer electrolyte (SPE) fuel cell which comprises a solid polymer electrolyte membrane and operates at relatively low temperatures.

SPE fuel cells employ a membrane electrode assembly (MEA) which comprises the solid polymer electrolyte or ion-exchange membrane disposed between the cathode and anode. Each electrode contains a catalyst layer, comprising an appropriate catalyst, located proximate or adjacent to the solid polymer electrolyte membrane. The catalyst is typically a precious metal composition (e.g., platinum metal black or an alloy thereof) and may be provided on a suitable support (e.g., fine platinum particles supported on a carbon black support). The catalyst layers may contain an ionomer similar to that used for the solid polymer electrolyte membrane (e.g., Nafion® commercially available from E.I. DuPont de Nemours and Company). The electrodes may also contain a porous, electrically conductive substrate that may be employed for purposes of mechanical support, electrical conduction, and/or reactant distribution, thus serving as a fluid diffusion layer. Flow field plates, having passages for directing the reactants across one surface of each electrode or electrode substrate, are disposed on each side of the MEA. In operation, the output voltage of an individual fuel cell under load is generally below one volt. Therefore, in order to provide greater output voltage, numerous cells are usually physically stacked together and are electrically coupled in series to create a higher voltage fuel cell series stack.

During normal operation of a SPE fuel cell, fuel is electrochemically oxidized at the anode catalyst, typically resulting in the generation of protons, electrons, and possibly other species depending on the fuel employed, such as hydrogen, reformate, methanol, etc. The protons are conducted from the reaction sites at which they are generated, through the electrolyte, to electrochemically react with the oxidant, such as oxygen or air, at the cathode catalyst. The electrons travel through an external circuit providing useable power and then react with the protons and oxidant at the cathode catalyst to generate water reaction product.

In some fuel cell applications, the demand for power can essentially be continuous and thus the stack may rarely be shutdown (such as for maintenance). However, in many applications (e.g., automotive), a fuel cell stack may frequently be stopped and restarted with significant storage (i.e., nonoperational) periods in between. Such cyclic use can pose certain problems in fuel cell stacks related to the water content remaining and its distribution in the stack after shutdown. For instance, accumulations of liquid water in the stack can result from too much water remaining and/or undesirable distribution during shutdown. Such accumulations of liquid water can adversely affect cell performance by blocking the flow of reactants and/or by-products. Perhaps even worse, if the fuel cell stack is stored at below freezing temperatures, liquid water accumulations in the cells can freeze and possibly result in permanent damage to the cells. On the other hand, with too little water remaining, the conductivity of the membrane electrolyte used in SPE fuel cells can be substantially reduced, with resulting poor power capability from the stack when restarting.

A conventional approach is to remove water in the fuel cell prior to storage by purging one or more flow fields with dry gas prior to shutdown. One important problem presented by this approach of purging with dry gas before shutdown is that due to the high gas flow rate and length of time required to remove all water from the fuel cell passages before shutdown, the membrane is also dried, and overtime, this. drying will result in degradation of the membrane.

JP 2004-152600 presents an alternative approach to the conventional dry purge. The reference attempts to avoid the problems presented by the need for high dry gas flow rates of the conventional approach on shutdown by first removing residual water in the system by a high gas flow rate humidified purge, followed by a lower flow rate non-humidified purge. When it is desired to stop operation of fuel cell 1, humidified gas, e.g., oxidant from humidifier 19, is supplied to fuel cell 1 at a flow rate greater than that used during idle operation of the fuel cell. Non-humidified gas, e.g., oxidant that bypasses humidifier 19, is then supplied to fuel cell 1 at a flow rate lower than that of the humidified gas. To purge the fuel side of fuel cell 1, the reference suggests the use of an inert gas, such as nitrogen. However, although purging with lower dry gas flow rate prior to shutdown as proposed in JP 2004-152600 may reduce drying of the membrane, because the final shutdown step is a drying step, the technique proposed in JP 2004-152600 will still result in some degree of drying of the membrane, and accordingly, slower startups due to the ohmic resistance of the dried membrane, and degradation of the membrane over time.

Given these difficulties, there remains a need in the art to develop procedures and/or design modifications in order to improve water removal from fuel cell system components on shutdown but which do not dry out the membrane. The present systems and methods address these and other needs, and provide further related advantages.

### BRIEF SUMMARY OF THE INVENTION

The present systems and methods relate to fuel cells and, more particularly, to the operation of fuel cell systems to improve their freeze start capability.

It has been discovered that by following a drying step with a rehumidifying step prior to shutdown of a fuel cell stack, improved water distribution and membrane hydration and accordingly, an improved ability to restart following freezing, can be obtained.

In one embodiment, a method of shutting down a power generating system comprising a fuel cell stack connectable to an external circuit for supplying power to the external circuit, the stack comprising at least one fuel cell, the method comprising directing a drying stream through at least a portion of the stack, directing a rehumidifying stream through at least a portion of the stack, and shutting down the power generating system.

In an alternative embodiment, a method of shutting down a power generating system comprising a fuel cell stack connectable to an external circuit for supplying power to the external circuit, the stack comprising at least one fuel cell, the method comprising purging water from at least a portion of the stack, rehumidifying the stack, and shutting down the power generating system.

In another alternative embodiment, a method of shutting down a power generating system comprising a fuel cell stack connectable to an external circuit for supplying power to the external circuit, the stack comprising at least one fuel cell, the method comprising operating the stack under a drying condition, rehumidifying the stack to a desired water content, and shutting down the power generating system.

In still another embodiment, a power generating system comprising a fuel cell stack connectable to an external circuit for supplying power to the external circuit, the stack comprising at least one fuel cell, and means for shutting down the power generating system by directing a drying stream through at least a portion of the stack, directing a rehumidifying stream through at least a portion of the stack, and shutting down the power generating system.

In an alternative embodiment, a power generating system comprising a fuel cell stack connectable to an external circuit for supplying power to the external circuit, the stack comprising at least one fuel cell, and means for shutting down the power generating system by purging water from at least a portion of the stack, rehumidifying the stack, and shutting down the power generating system.

In another alternative embodiment, a power generating system comprising a fuel cell stack connectable to an external circuit for supplying power to the external circuit, the stack comprising at least one fuel cell, and means for shutting down the power generating system by operating the stack under a drying condition, rehumidifying the stack to a desired water content, and shutting down the power generating system.

These and other aspects of the present systems and methods will be apparent upon reference to the attached figures and following detailed description.

### BRIEF DESCRIPTION OF THE SEVERAL VIEWS OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1 is a schematic view of a SPE fuel cell stack.

FIG. 2 is a schematic view of a power generation system including the fuel cell stack of FIG. 1.

FIG. 3 is a graph that shows the measured water content versus the distance from the inlet for a fuel cell shutdown using a conventional method.

FIG. 4 is a graph that shows the measured water content versus the distance from the inlet for a fuel cell shutdown employing an embodiment of the present techniques.

FIG. 5 is a graph that shows the individual cell voltages versus elapsed time observed during a startup of a fuel cell system shutdown using a conventional method.

FIG. 6 is a graph that shows the individual cell voltages versus elapsed time observed during a startup of a fuel cell system shutdown employing an embodiment of the present techniques.

### DETAILED DESCRIPTION OF THE INVENTION

In the following detailed description, certain specific details are set forth in order to provide a thorough understanding of various embodiments of the present systems and methods. However, one skilled in the art will understand that the present systems and methods may be practiced without these details. In other instances, well known structures associated with fuel cell stacks and fuel cell systems have not been described in detail to avoid unnecessarily obscuring the descriptions of the embodiments of the present systems and methods.

Unless the context requires otherwise, throughout the specification and claims which follow, the word “comprise” and variations thereof, such as “comprises” and “comprising” are to be construed in an open, inclusive sense, that is as “including but not limited to”.

The present methods and systems are particularly suitable for SPE fuel cell stacks, though those of ordinary skill in the art will appreciate that they can be employed with other types of fuel cell stacks.

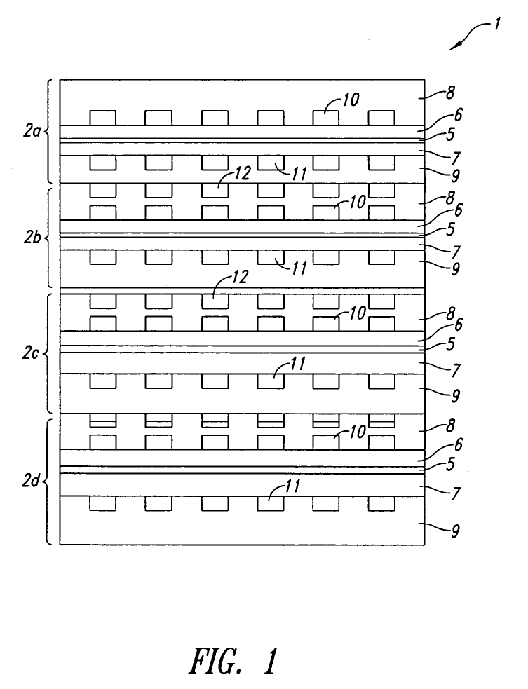

An exemplary SPE fuel cell stack 1 is shown schematically in FIG. 1. Fuel cell stack 1 comprises a plurality of stacked fuel cells 2a-2d (collectively 2). Each cell 2 has an MEA comprising a solid polymer electrolyte membrane 5, and suitable catalyst layers (not shown) serving as the anode and cathode in each fuel cell which may be applied to opposing faces of each membrane 5. The MEA may also comprise an anode gas diffusion layer (GDL) 6 and a cathode gas diffusion layer (GDL) 7. Adjacent to the anode and cathode GDLs 6 and 7 in each fuel cell 2 are an anode flow field plate 8 and a cathode flow field plate 9, respectively. Each flow field plate 8, 9 comprises one or more reactant passages, shown in FIG. 1 as anode flow field channels 10 and cathode flow field channels 11, respectively. As depicted, each anode flow field plate 8 (other than that in the top cell 2a) also contains coolant flow field channels 12. Typically, negative and positive bus plates (not shown) and a pair of compression plates (not shown) are also provided at either end of the stack. Fluids are supplied to and from the reactant and coolant flow field channels 10, 11 via various ports and manifolds (not shown).

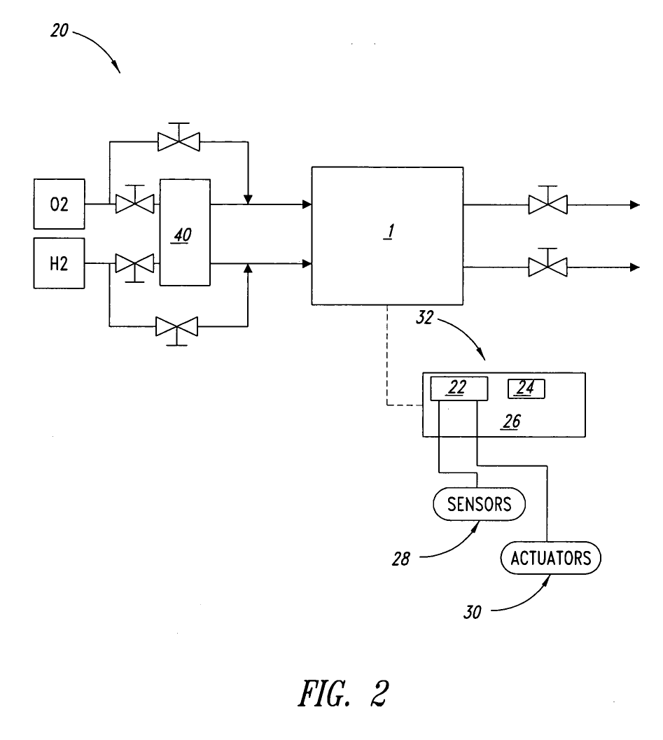

As shown in FIG. 2, typically, fuel cell stack 1 is part of a power generation system 20 that will also comprise various sensors 28 and actuators 30 distributed throughout power generation system 20 and an electronic control system 32 having various electrical and electronic components on a circuit board 26. Circuit board 26 may carry a microprocessor or microcontroller 22 that is appropriately programmed or configured to carry out the operation of power generation system 20. Control system 32 may also include a persistent memory 24, such as an EEPROM portion of microcontroller 22 or as a discrete nonvolatile controller-readable media.

According to the present systems and methods, on shutdown, initial drying of stack 1 is followed by rehumidification. Without being bound by theory, by flowing humidified gases along the dry fuel cells 2, membrane 5 is partially hydrated (i.e., because the relative humidity of the stream is greater than 0%), but reactant passages 10, 11, membrane 5 and GDLs 6, 7 remain dry because no condensation in these components occurs since the incoming gas stream does not cause liquid water to collect. Thus, reactant passages 10, 11 and the MEA components are dried in preparation for shutdown (i.e., liquid water is removed that in the event of freezing could potentially damage fuel cells 2 or block reactant passages 10, 11 and cause reactant starvation during startup), while membrane 5 remains humidified.

In some embodiments, the drying may be accomplished by known techniques, including flowing a dried or unhumidified reactant stream through at least one of the flow field channels 10, 11, or other purging techniques such as those described in U.S. Pat. No. 6,479,177. Alternatively, the drying stream may comprise a dried or unhumidified inert fluid stream, such as nitrogen.

In other embodiments, drying may be accomplished by operation of the power generation system in such a way as to create a drying condition, such as is described in U.S. Patent Application Publication No. 2003/0186093. For example, as shown in FIG. 2, power generation system 20 may include a humidification system 40 for humidifying one or more of the fuel and oxidant streams, and a drying condition may be created by ceasing or adjusting operation of humidification system 40 to reduce the humidification level of the reactant stream(s) to be dried. Alternatively, at least part of the reactant stream(s) to be dried may be directed to bypass humidification system 40. In still other embodiments, accomplishment of the drying step may be effected by adjusting one or more system operational parameters, such as the relative humidity, stoichiometry, flow rate, and pressure of at least one of the fuel and oxidant streams, or the temperature of fuel cell stack 1.

The length of time the drying stream is supplied to system, as well as the relative humidity and flow rate of the stream, may be predetermined or may be determined based at least in part on a measured system parameter. For example, a predetermined time necessary to reach a desired level of dryness of the system may be established through empirical trials, or alternatively, a table of predetermined times that depends on varying factors, such as external temperature, length of time the system was operated or is anticipated to be shutdown, the amount of water present in the system or fuel cell stack 1 at shutdown, etc., may be utilized. Similarly, the length of time the drying stream is supplied to the system, the relative humidity of the stream and/or the flow rate of the stream, may be determined during the shutdown procedure itself. For example, control system 32 may include one or more sensors 28 to measure the water content of the system, fuel cell stack 1, membrane 5 and/or other components and/or to measure other parameters, such as the resistance, impedance or voltage of one or more fuel cells 2 in fuel cell stack 1, or the relative humidity of the fuel and/or oxidant stream(s) exiting stack 1. Persons of ordinary skill in the art will appreciate that many other factors could be used to select one or more appropriate predetermined times and/or system parameters.

As with the drying step, the length of time the humidified stream is supplied to the system, as well as the level or humidity and flow rate of the stream, may be predetermined or dependent on a measured system parameter. For example, in some embodiments, the relative humidity of the stream may be in the range of 10% to 95%, and in other embodiments, in the range of 20% to 95%. In other embodiments, a predetermined time necessary to reach a desired level of the system or membrane 5 humidification may be established through empirical trials, or alternatively, a table of predetermined times may be developed in dependence on varying factors. Similarly, the length of time the humidifying stream is supplied to power generation system 20 may be determined during the shutdown procedure itself, such as via one or more sensors 28 to measure the water content of the system, fuel cell stack 1, membrane 5 and/or other components and/or other parameters, such as the resistance, impedance or voltage of one or more fuel cells 2, or the relative humidity of the fuel and/or oxidant stream(s) exiting fuel cell stack 1. Again, persons of ordinary skill in the art will appreciate that many other factors could be used to select one or more appropriate predetermined times and/or system parameters.

In other embodiments, the durations of the drying and the rehumidifying operations may be determined relative to one another. For example, in one embodiment, the rehumidifying operation may be 2 to 3 times as long as the drying operation.

Output of power from the system to an external load may be interrupted prior to initiating the present techniques, or in alternative embodiments it may be interrupted after one or both of the drying and rehumidifying operations. In some embodiments, the fuel cell 2 may be a solid polymer electrolyte fuel cell, and the reactant streams hydrogen and air.

The following examples have been included to illustrate different embodiments and aspects of the present systems and methods but they should not be construed as limiting in any way.

### EXAMPLE 1

A Ballard fuel cell stack (5 cells) was operated overnight at approximately 300 A. Air was supplied to the fuel cell stack as the oxidant at approximately a pressure of 15 psig, dewpoint temperature of 58° C. and a stoichiometry of 1.8. (Stoichiometry is the ratio of fuel or oxidant supplied to that consumed in the generation of electrical power in the fuel cell.) Substantially pure hydrogen was supplied to the stack at approximately a pressure of 18 psig, dewpoint temperature of 56° C. and a stoichiometry of 2. The coolant inlet and outlet temperatures were approximately 60° C. and 70° C., respectively, during the overnight operation. The load was then reduced to 30 A and the stack was operated for an additional 15 minutes, with air supplied at approximately 5 psig, dewpoint 58° C. and stoichiometry 1.8 and hydrogen supplied at approximately 8 psig, dewpoint 56° C. and stoichiometry 9.6. The coolant inlet and outlet temperatures were both 60° C.

The fuel cell stack was subsequently shutdown by removing the load and turning off the supply of both reactants to the fuel cell stack. The coolant temperature was left at 60° C. The fuel cell stack was subjected to a two-tier dry gas purge, initiated by causing both reactant supply streams to bypass the humidifier. The cathode side of the fuel cell stack was purged by directing a low flow rate stream of oxidant to the fuel cell stack for approximately 45 seconds, followed by forced cooling of the fuel cell stack to 5° C. Both the anode and the cathode sides of the fuel cell stack were then purged by directing low flow rate streams of hydrogen and oxidant, respectively, to the fuel cell stack for approximately 15 seconds.

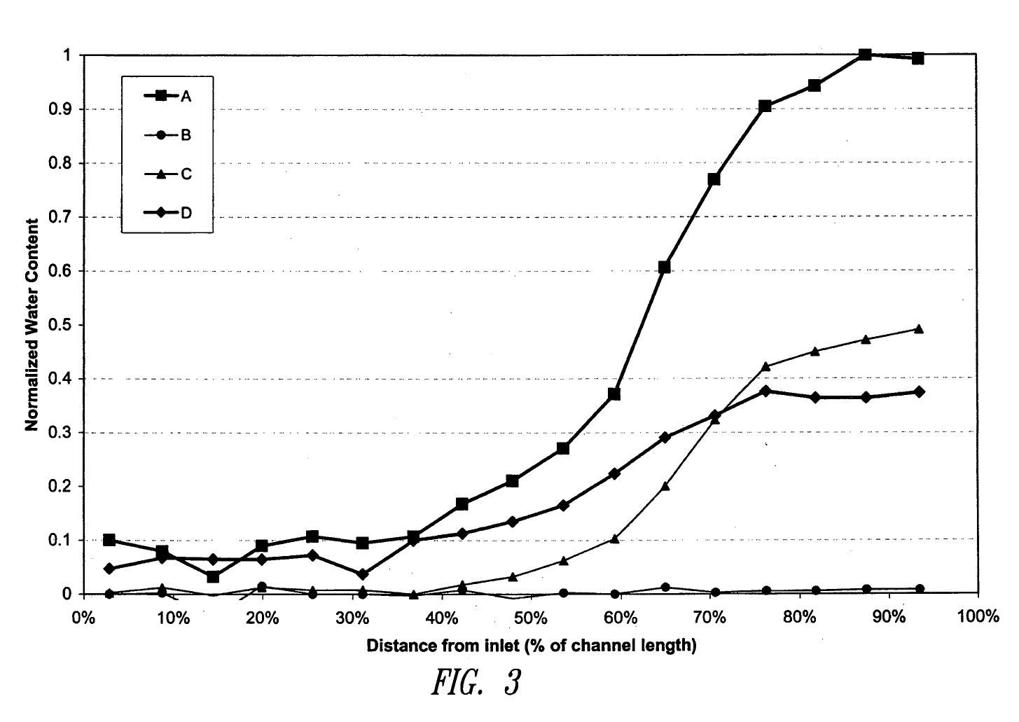

Water distribution within the fuel cell stack was evaluated by disassembling the fuel cell stack and visually assessing and measuring the hydration profile of the MEAs along the length of the cell and through the cross-section of the MEA. FIG. 3 shows the normalized water content (maximum MEA water content at full load=1) versus the distance from the reactant inlets. Curve A represents the normalized water content of the total MEA, curve B that of the anode GDL, curve C that of the cathode GDL and curve D that of the catalyst-coated membrane (CCM). As can be seen from the figure, water distribution along the length of the fuel cell stack varied, despite the purging with dry gases during shutdown. In particular, water droplets were found in the channels in the area of the cell closest to the outlet. For all components except the anode GDL, water distribution along the length of the fuel cell stack increased as the distance from the inlet increased, despite the purging with dry gases during shutdown. In particular, while the water content of the CCM, cathode GDL and total MEA was low in the area of the cell closest to the inlet, the water content for the same components in the area of the cell furthest away from the inlet was significantly higher.

### EXAMPLE 2

A Ballard fuel cell stack (5 cells) was operated for at least an hour at approximately 300 A. Air was supplied to the fuel cell stack as the oxidant at approximately a pressure of 15 psig, dewpoint temperature of 58° C. and a stoichiometry of 1.8. Substantially pure hydrogen was supplied to the fuel cell stack at approximately a pressure of 18 psig, dewpoint temperature of 56° C. and a stoichiometry of 2. The coolant inlet and outlet temperatures were approximately 60 and 70° C., respectively.

The fuel cell stack was subsequently shutdown by removing the load and providing air and hydrogen to the fuel cell stack at approximately 0.02 and 0.01 slpm/cm² fuel cell active area, respectively, for 5 minutes, with both reactant streams bypassing the humidifier and the coolant inlet temperature remaining at 60° C. (The coolant outlet temperature dropped to 60° C. during the purging, since no power production, and hence heat generation, was occurring.) Both reactant streams were then switched back to pass through the humidifier, and were supplied to the fuel cell stack at 0.02 and 0.01 slpm/cm² fuel cell active area for air and fuel respectively, and dewpoint temperatures of 58° C. and 56° C., respectively (relative humidity of approximately 95%) for 20 minutes. Both reactant streams were then shut off and the fuel cell stack was force cooled to 5° C.

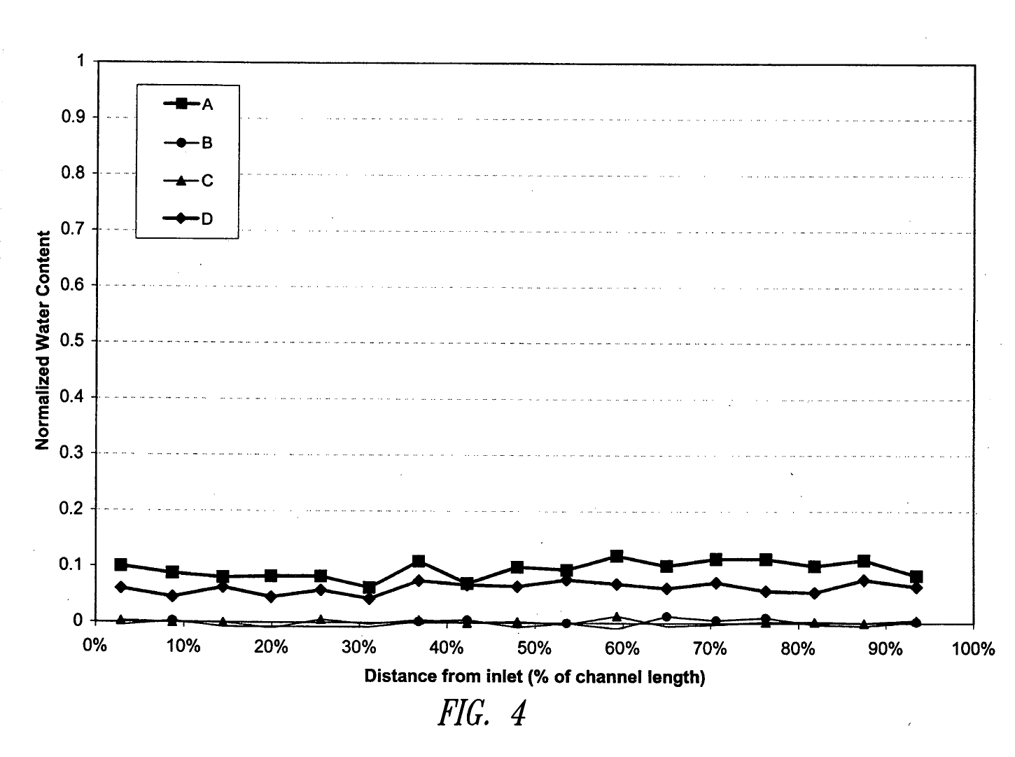

As with the previous example, water distribution within the fuel cell stack was evaluated by disassembling the fuel cell stack and visually assessing and measuring the hydration profile of the MEAs along the length of the fuel cell and through the cross-section of the MEA. FIG. 4 shows the measured water content versus the distance from the inlet. As in FIG. 3, curve A represents the normalized water content of the total MEA, curve B that of the anode GDL, curve C that of the cathode GDL and curve D that of the CCM. In contrast to the water distribution observed following the shutdown procedure outlined in Example 1, after the shutdown procedure outlined in Example 2, for all components water distribution along the length of the fuel cell stack was relatively uniform. The water content of all components was very low along the length of the fuel cell while the membrane was uniformly hydrated along the length of the fuel cell stack.

Accordingly, by employing the present techniques, the reactant passages and the GDLs were dried while the membrane was left humidified, with the water content of all components being relatively uniform along the length of the fuel cell.

### EXAMPLE 3

A Ballard fuel cell stack (20 cells) was operated for at least an hour at approximately 300 A. Air was supplied to the fuel cell stack as the oxidant at approximately a pressure of 15 psig, dewpoint temperature of 59° C. and a stoichiometry of 1.8. A fuel blend of 70% hydrogen (balance nitrogen) was supplied to the fuel cell stack at approximately a pressure of 18 psig, dewpoint temperature of 58° C. and a stoichiometry of 2. The coolant inlet and outlet temperatures were approximately 61° C. and 71° C., respectively. The fuel cell stack was subsequently subjected to a simulated load cycle for approximately 12 minutes, wherein the load was varied between approximately 1% and 50% power, varying the reactant supply pressures and stoichiometries in conjunction with the load variations.

The fuel cell stack was then shutdown by removing the load and performing the two-tier drying purge described in Example 1, except that the fuel cell stack was force cooled to −15° C. following completion of the second purge step. After holding the fuel cell stack at −15° C. for 10 minutes, the fuel cell stack was restarted, increasing the load in stages from zero as the stack voltage increased, bypassing the humidifiers for both reactant streams until the stack temperature reached at least 40° C., and adjusting the pressures and stoichiometries of the reactants as the load was increased. The voltage of the individual fuel cells was monitored during the startup. The fuel cell system employed a dual loop cooling subsystem, such as that described in commonly-owned U.S. patent application Ser. No. 10/936,461, filed Sep. 8, 2004 and titled “Cooling Subsystem For An Electrochemical Fuel Cell System,” with a startup coolant loop comprising a heater and a startup or microcoolant pump fluidly coupled to the fuel cell stack, and a standard or main coolant loop comprising a standard pump and a stack valve. During the startup, the stack valve initially remained closed so that the fuel cell stack was fluidly isolated from the main coolant loop. Once the coolant inlet temperature reached 60° C., the stack valve was opened to allow coolant to flow through the main loop.

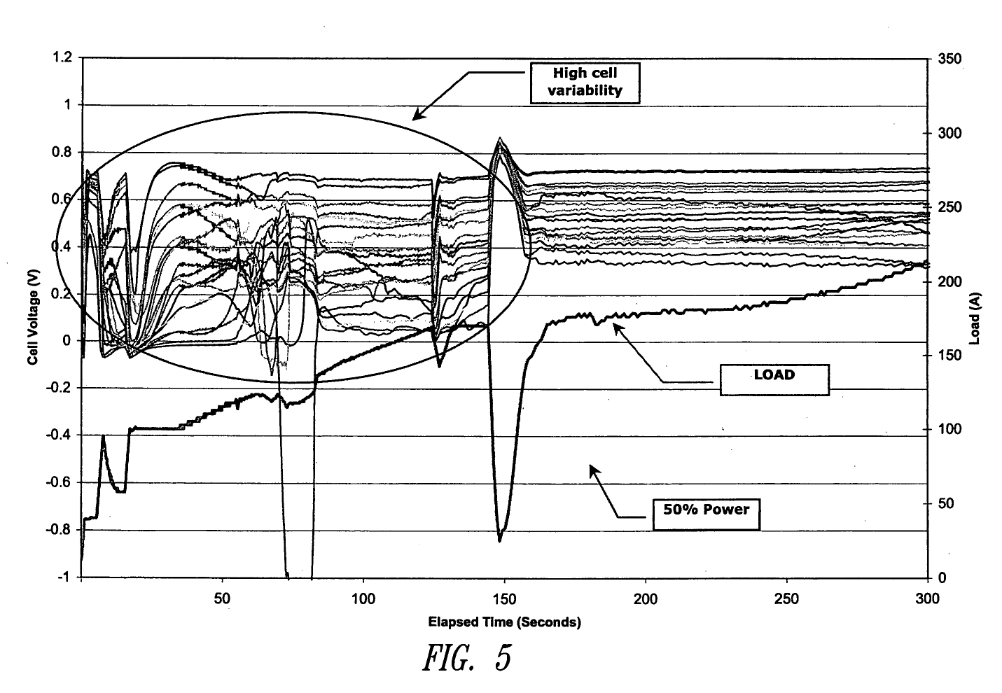

FIG. 5 shows a plot number of the individual cell voltages observed during the startup versus elapsed time from startup. The time required for the fuel cell stack to reach 50% power was 180 seconds, and as can be seen from FIG. 5, the fuel cell stack experienced significant cell-to-cell voltage variability during the startup, with a number of fuel cells showing negative cell voltages (i.e., going into voltage reversal) for certain periods of time, well past initial application of the load. Unwanted voltage reversal may occur where a power-producing fuel cell in series is forced to the opposite polarity by the other fuel cells in the series. In fuel cell stacks, this can occur when a fuel cell is unable to produce from the fuel cell reactions the current being forced through it by the rest of the fuel cells. Groups of fuel cells within a fuel cell stack can also undergo voltage reversal and even entire stacks can be driven into voltage reversal by other fuel cell stacks in an array. Aside from the loss of power associated with one or more fuel cells going into voltage reversal, this situation poses reliability concerns. Undesirable electrochemical reactions may occur, which may detrimentally affect fuel cell components. Component degradation reduces the reliability and performance of the fuel cell, and in turn, its associated stack and array.

### EXAMPLE 4

A Ballard fuel cell stack (20 cells) was operated for at least an hour at approximately 300 A. Air was supplied to the fuel cell stack as the oxidant at approximately a pressure of 15 psig, dewpoint temperature of 59° C. and a stoichiometry of 1.8. A fuel blend of 70% hydrogen (balance nitrogen) was supplied to the fuel cell stack at approximately a pressure of 17.6 psig, dewpoint temperature of 58° C. and a stoichiometry of 2.0. The coolant inlet and outlet temperatures were approximately 61° C. and 71° C., respectively. The fuel cell stack was subsequently subjected to a simulated load cycle for approximately 12 minutes, wherein the load was varied between approximately 1% and 50% power, varying the reactant supply pressures and stoichiometries in conjunction with the load variations.

The fuel cell stack was subsequently shutdown by removing the load and providing unhumidified air and fuel to the fuel cell stack at approximately 0.02 slpm/cm² fuel cell active area at pressures of approximately 9 psig and 12 psig respectively, for 5 minutes, with both reactant streams bypassing the humidifier and the coolant inlet temperature remaining at 57° C. Both reactant streams were then switched back to pass through the humidifier, and were supplied to the fuel cell stack at approximately the same flow rates and pressures used during the unhumidified purge step at a dewpoint temperature of approximately 52° C. (relative humidity of approximately 65%) for 20 minutes. During the second stage of the shutdown, coolant was supplied to the fuel cell stack at an inlet temperature of approximately 63° C. Both reactant streams were then shut off and the fuel cell stack was force cooled to −15° C. After holding the fuel cell stack at −15° C. for 10 minutes, the fuel cell stack was restarted using the same procedure as that outlined in Example 3 above.

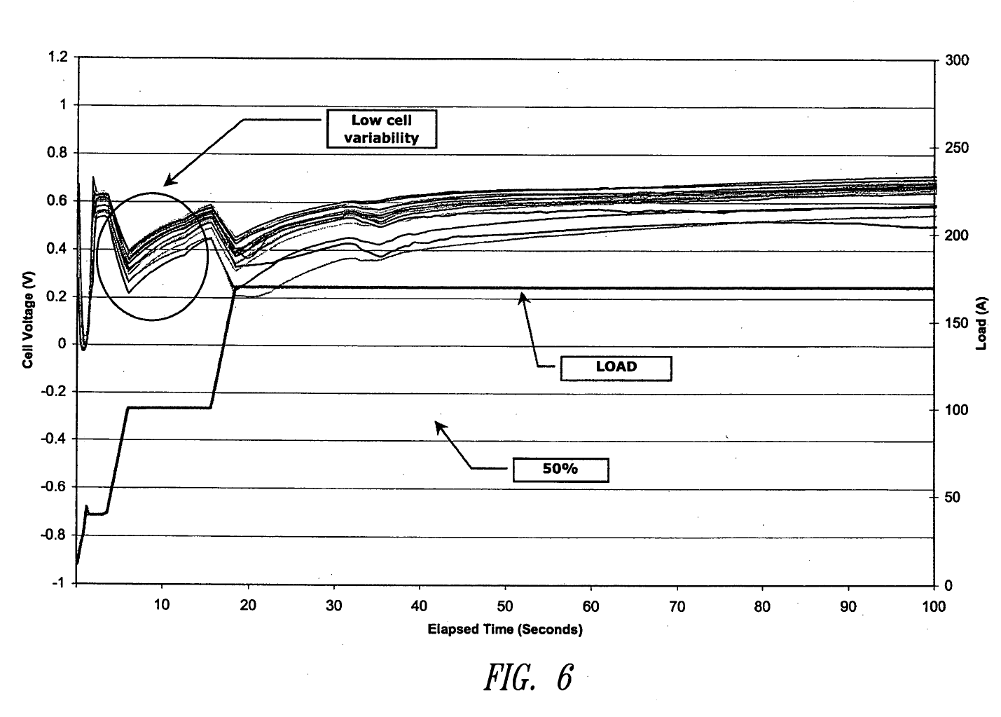

FIG. 6 shows the individual cell voltages observed during the startup versus elapsed time from startup. The time required for the stack to reach 50% power was 41 seconds. As can be seen from FIG. 6, in contrast to the results obtained in Example 3, minimal cell-to-cell variability was observed, and except very briefly on initial application of the load, no fuel cells were observed to go into reversal. Because all of the fuel cells performed well, the ramping up of the load was able to occur much more quickly than in Example 3, i.e., the load reached 170 A within 20 seconds of initiation of the startup procedure compared with the more than 150 seconds required in Example 3.

Accordingly, by using the present shutdown techniques, startup time was greatly reduced, as was the variability in the cell voltage of individual fuel cells.

### EXAMPLE 5

A Ballard fuel cell stack (20 cells) underwent a series of tests to compare startup behavior where the rehumidifying step of the present technique was performed at varying relative humidities. Prior to each test, the fuel cell stack was operated for at least an hour at approximately 300 A. During this period of operation, air was supplied to the fuel cell stack as the oxidant at approximately a pressure of 15 psig, dewpoint temperature of 61° C. and a stoichiometry of 1.8. Substantially pure hydrogen was supplied to the fuel cell stack at approximately a pressure of 18 psig, dewpoint temperature of 61° C. and a stoichiometry of 1.9. The coolant inlet and outlet temperatures were approximately 61° C. and 71° C., respectively. The fuel cell stack was subsequently shutdown by removing the load and providing unhumidified air and fuel to the stack for 5 minutes as described in Example 4 above.

Rehumidification was then performed by switching the reactant streams back to pass through the humidifier for 20 minutes as in Examples 2 and 4 as follows:
(a) 65% relative humidity air and fuel streams at approximately 60° C. dewpoint with the coolant inlet temperature at approximately 67° C.;
(b) 40% relative humidity air and fuel streams at approximately 52° C. and 50° C. dewpoints respectively, with the coolant inlet temperature at approximately 63° C.; and
(c) 20% relative humidity air and fuel streams at approximately 39° C. and 37° C. dewpoints respectively, with the coolant inlet temperature at approximately 63° C.

Following the rehumidification, both reactant streams were then shut off and the fuel cell stack was force cooled to −15° C. After holding the fuel cell stack at −15° C. for 10 minutes, the fuel cell stack was restarted by gradually applying a load, with the reactants bypassing the humidifiers until the coolant inlet temperature reached at least 30° C., and adjusting the pressures and stoichiometries of the reactants as the load was increased. The fuel cell system comprised a dual loop cooling system similar to that described in Example 3 above, with the stack valve initially remaining closed so that the fuel cell stack was fluidly isolated from the standard coolant loop. Once the coolant inlet temperature reached 70° C., the stack valve was opened to allow coolant to flow through both loops. The time to 50% power was measured.

The startup times for tests (a) (approximately 65% relative humidity), (b) (approximately 40% relative humidity) and (c) (approximately 20% relative humidity) were 75 seconds, 75 seconds and 50 seconds, respectively.

The above examples demonstrate that by employing the present techniques, startup time (and accordingly MEA performance) can be significantly improved. Without being bound by theory, the present techniques enable consistent hydration in all directions of each unit cell while keeping the reactant passages, GDLs and catalyst layers free of liquid water and relatively dry, which avoids the problems associated with liquid water (and accordingly ice accumulation) at freezing temperatures, while at the same time avoiding excessive drying of the membrane, and accordingly, degradation of the membrane over time.

All of the U.S. patents, U.S. patent application publications, U.S. patent applications, foreign patents, foreign patent applications and non-patent publications referred to in this specification and/or listed in the Application Data Sheet, including but not limited to U.S. Ser. No. 10/936,461 filed Sep. 8, 2004 and entitled “Cooling Subsystem For An Electrochemical Fuel Cell System”; U.S. Pat. No. 6,479,177 and U.S. Patent Publication No. 2003/0186093, are incorporated herein by reference, in their entirety. Aspects of the present systems and methods can be modified, if necessary, to employ systems, circuits and concepts of the various patents, applications and publications to provide yet further embodiments of the present systems and methods.

These and other changes can be made to the invention in light of the above detailed description. In general, in the following claims, the terms used should not be construed to limit the invention to the specific embodiments disclosed in the specification, but should be construed to include all fuel cell systems, controllers and processors, actuators, and sensors that operate in accordance with the claims. Accordingly, the invention is not limited by the disclosure, but instead its scope is to be determined entirely by the following claims.

We claim:

1. A method of shutting down a power generating system in response to a shutdown command, the power generating system comprising a fuel cell stack connectable to an external circuit for supplying power to the external circuit, the fuel cell stack comprising at least one fuel cell, and the method comprising:
(a) directing a drying stream through at least a portion of the fuel cell stack;
(b) directing a rehumidifying stream through at least a portion of the fuel cell stack; and
(c) shutting down the power generating system.

2. The method of claim 1 wherein the power generating system further comprises an oxidant passage for directing an oxidant stream through at least a portion of the fuel cell stack and a fuel passage for directing a fuel stream through at least a portion of the fuel cell stack, and wherein directing a drying stream through at least a portion of the fuel cell stack comprises directing the drying stream through at least one of the oxidant and the fuel passages.

3. The method of claim 2 wherein the power generating system further comprises a humidifier for humidifying at least one of the oxidant and the fuel streams, and wherein directing a drying stream through at least a portion of the fuel cell stack comprises adjusting operation of the humidifier to reduce a humidification level of at least one of the oxidant and the fuel streams.

4. The method of claim 3 wherein adjusting operation of the humidifier to reduce a humidification level of at least one of the oxidant and the fuel streams comprises stopping operation of the humidifier.

5. The method of claim 3 wherein adjusting operation of the humidifier to reduce a humidification level of at least one of the oxidant and the fuel streams comprises bypassing at least a portion of the at least one of the fuel and oxidant streams around the humidifier.

6. The method of claim 2 wherein the oxidant stream and the fuel stream are directed through the stack in a counterflow arrangement.

7. The method of claim 2, further comprising:
directing the oxidant stream and the fuel stream through the fuel cell stack in a co-flow arrangement.

8. The method of claim 2 wherein directing the drying stream through at least one of the oxidant and the fuel passages comprises directing the drying stream through only one of the oxidant and the fuel passages.

9. The method of claim 1 wherein the power generating system further comprises an oxidant passage for directing an oxidant stream through the fuel cell stack and a fuel passage for directing a fuel stream through the fuel cell stack, and wherein directing a rehumidifying stream through at least a portion of the fuel cell stack comprises directing the rehumidifying stream through at least one of the oxidant and the fuel passages.

10. The method of claim 9 wherein directing the rehumidifying stream through at least one of the oxidant and the fuel passages comprises directing the rehumidifying stream through only one of the oxidant and the fuel passages.

11. The method of claim 9 wherein the power generating system further comprises a humidifier for humidifying at least one of the oxidant and the fuel streams, and wherein directing a rehumidifying stream through at least a portion of the fuel cell stack comprises adjusting operation of the humidifier to humidify at least one of the oxidant and the fuel streams to the fuel cell stack.

12. The method of claim 1 wherein directing the drying stream through at least a portion of the fuel cell stack comprises directing the drying stream through a same portion of the fuel cell stack as through which the rehumidifying stream is directed.

13. The method of claim 1 wherein the rehumidifying stream comprises a partially saturated stream of at least one of a fuel, an oxidant and an inert fluid.

14. The method of claim 13 wherein a relative humidity of the partially saturated stream is between about 10% and 95%.

15. The method of claim 14 wherein the relative humidity of the partially saturated stream is between about 20% and 65%.

16. The method of claim 1 wherein the drying stream comprises an unhumidified stream of at least one of a fuel, an oxidant and an inert fluid.

17. The method of claim 1 wherein the drying stream comprises a dry stream of at least one of a fuel, an oxidant and an inert fluid.

18. The method of claim 1 wherein the at least one fuel cell is a solid polymer electrolyte fuel cell.

19. The method of claim 1 wherein the fuel cell stack comprises a plurality of fuel cells stacked and electrically coupled in series.

20. The method of claim 1 wherein the drying stream and the rehumidifying stream are reactant streams.

21. The method of claim 1 wherein the drying stream and the rehumidifying stream comprise an inert fluid.

22. The method of claim 1, further comprising:
interrupting the supply of power from the fuel cell stack to the external circuit.

23. The method of claim 22 wherein the supply of power from the fuel cell stack is interrupted prior to directing the drying stream through at least a portion of the fuel cell stack.

24. The method of claim 22 wherein the supply of power from the fuel cell stack is interrupted prior to directing a rehumidifying stream through at least a portion of the fuel cell stack.

25. The method of claim 1 wherein each of the directing a drying stream through at least a portion of the stack and the directing a rehumidifying stream through at least a portion of the stack continues until at least one performance parameter indicates that a desired water content in the fuel cell stack has been reached.

26. The method of claim 25 wherein the at least one performance parameter is selected from the group consisting of:
(a) a resistance of at least one fuel cell in the fuel cell stack;
(b) an impedance of at least one fuel cell in the fuel cell stack;
(c) a voltage of at least one fuel cell in the fuel cell stack;
(d) a stack temperature; and
(e) a relative humidity of at least one of a fuel and an oxidant stream.

27. The method of claim 25 wherein the at least one fuel cell comprises a membrane electrolyte, and the at least one performance parameter corresponds to a membrane moisture level.

28. The method of claim 1 wherein a duration of the directing the drying stream through at least a portion of the fuel cell stack and a duration of the directing the rehumidifying stream through at least a portion of the fuel cell stack are predetermined.

29. The method of claim 28 wherein the duration of the directing the drying stream through at least a portion of the fuel cell stack is about 5 minutes and the duration of the directing the rehumidifying stream through at least a portion of the fuel cell stack is about 20 minutes.

30. The method of claim 1 wherein the directing a drying stream through at least a portion of the fuel cell stack continues until a predetermined volume of the drying stream has been directed through the fuel cell stack and the directing a rehumidifying stream through at least a portion of the fuel cell stack continues until a predetermined volume of the rehumidifying stream has been directed through the fuel cell stack.

31. The method of claim 1 wherein a duration of the directing a drying stream through at least a portion of the fuel cell stack is about 2-3 times a duration of the directing a rehumidifying stream through at least a portion of the fuel cell stack.

32. The method of claim 1 wherein a duration of the directing a drying stream through at least a portion of the fuel cell stack is between about 0.015 second s/cm² of an active area of the fuel cell and about 2 seconds/cm² of the active area of the fuel cell.

33. The method of claim 1 wherein a flow rate of the drying stream through each fuel cell and a flowrate of the rehumidifying stream through each fuel cell are between about 0.0003 slpm/cm² of active area of the fuel cell and about 0.05 slpm/cm² of active area of the fuel cell.

34. The method of claim 1 wherein a duration of the directing a rehumidifying stream through at least a portion of the fuel cell stack is between about 0.015 seconds/cm² of an active area of the fuel cell and about 6 seconds/cm² of the active area of the fuel cell.

35. The method of claim 1 wherein directing a drying stream through at least a portion of the fuel cell stack comprises adjusting at least one system operational parameter to supply the drying stream to the fuel cell stack.

36. The method of claim 35 wherein the system operational parameter is selected from the group consisting of:
(a) a relative humidity of at least one of a fuel and an oxidant stream;
(b) a stoichiometry of at least one of a fuel and an oxidant stream;
(c) a flow rate of at least one of a fuel and an oxidant stream;
(d) a pressure of at least one of a fuel and an oxidant stream; and
(e) a stack temperature.

37. A method of shutting down a power generating system comprising a fuel cell stack connectable to an external circuit for supplying power to the external circuit, the fuel cell stack comprising at least one fuel cell, the method comprising:
(a) purging water from at least a portion of the fuel cell stack;
(b) rehumidifying the fuel cell stack; and
(c) shutting down the power generating system.

38. A method of shutting down a power generating system comprising a fuel cell stack connectable to an external circuit for supplying power to the external circuit, the fuel cell stack comprising at least one fuel cell, the method comprising:
(a) operating the fuel cell stack under a drying condition;
(b) rehumidifying the fuel cell stack to a desired water content; and
(c) shutting down the power generating system.

39. The method of claim 38 wherein rehumidifying the fuel cell stack to a desired water content comprises creating a predetermined water profile in the fuel cell stack.

40. The method of claim 38 wherein the fuel cell comprises a membrane and passages for directing fuel and oxidant to the fuel cell stack, and wherein rehumidifying the fuel cell stack to a desired water content comprises hydrating the membrane while keeping the passages free of liquid water.

41. A power generating system comprising a fuel cell stack connectable to an external circuit for supplying power to the external circuit, the fuel cell stack comprising at least one fuel cell, and means responsive to a shutdown condition for directing a drying stream through at least a portion of the fuel cell stack, directing a rehumidifying stream through at least a portion of the fuel cell stack after directing the drying stream through the at least a portion of the fuel cell stack, and shutting down the power generating system after directing the rehumidifying stream through at least a portion of the fuel cell stack.

42. The power generating system of claim 41, wherein the power generating system further comprises:
(a) a sensor assembly connected to the fuel cell stack for monitoring at least one performance parameter;
(b) a controller for controlling the power generating system in response to the at least one performance parameter; and
(c) a control system communicative with the sensor assembly and the controller, such that upon receipt of a shutdown instruction from the control system, the controller is operable to shutdown the power generating system.

43. The power generating system of claim 42 wherein the sensor assembly comprises at least one sensor for monitoring the at least one performance parameter.

44. The power generating system of claim 42 wherein the at least one performance parameter is selected from the group consisting of:
(a) a resistance of at least one fuel cell in the fuel cell stack;
(b) an impedance of at least one fuel cell in the fuel cell stack;
(c) a voltage of at least one fuel cell in the fuel cell stack;
(d) a stack temperature; and
(e) a relative humidity of at least one of a fuel and an oxidant stream.

45. The power generating system of claim 42 wherein the controller comprises apparatus to control at least one stack operational parameter selected from the group consisting of:
(a) a relative humidity of at least one of a fuel and an oxidant stream;
(b) a stoichiometry of at least one of a fuel and an oxidant stream,
(c) a flow rate of at least one of a fuel and an oxidant stream;
(d) a pressure of at least one of a fuel and an oxidant stream; and
(e) a stack temperature.

46. The power generating system of claim 42 wherein the control system comprises a microcontroller.

47. A power generating system comprising a fuel cell stack connectable to an external circuit for supplying power to the external circuit, the fuel cell stack comprising at least one fuel cell, and means responsive to a shutdown condition for purging water from at least a portion of the fuel cell stack, rehumidifying the fuel cell stack after purging the water from the at least a portion of the fuel cell stack, and shutting down the power generating system after rehumidifying the fuel cell stack.

48. A power generating system comprising a fuel cell stack connectable to an external circuit for supplying power to the external circuit, the fuel cell stack comprising at least one fuel cell, and means responsive to a shutdown signal for operating the fuel cell stack under a drying condition, rehumidifying the fuel cell stack to a desired water content after operating the fuel cell stack under the drying condition, and shutting down the power generating system after rehumidifying the fuel cell stack to the desired water content.
